(19) United States
(12) Patent Application Publication
(10) Pub. No.: US 2001/0041593 A1
(43) Pub. Date: Nov. 15, 2001

(54) Mobile communication device and data concealing method

(75) Inventor: Hideaki Asada, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/848,598

(22) Filed: May 3, 2001

(30) Foreign Application Priority Data
May 10, 2000 (JP) 2000-137261

(51) Int. Cl. H04M 1/00

(52) U.S. Cl. 455/558; 455/410

(57) ABSTRACT

A mobile communication device allowing data to be stored and programs to be delivered with safety is disclosed. The mobile communication device is detachably connected to a card having at least an encryption key generator therein. The encryption key generator generates an encryption key using a predetermined code. Encryption of data to be stored in the memory and decryption of encrypted data stored in the memory are performed using the encryption key received from the card.

### BACKGROUND OF THE INVENTION

1. Field of the Invention

The present invention relates to a mobile communication device such as a mobile telephone, a portable telephone, or a cellular telephone and in particular to a concealing technique of data received or generated by the mobile communication device.

2. Description of the Related Art

With the development of data communication technology using the Internet, mobile telephones have handled various types of data in recent years. For example, data such as image, electronic mail, contact list, and incoming call melody, as well as voice data, are recently handled in the mobile telephone.

FIG. 1 is a block diagram showing an example of the general configuration of a conventional mobile telephone capable of handling such data.

The mobile telephone is mainly composed of a central processing unit (CPU) 100, an antenna 101, a key-input portion 102, a microphone 103 and a built-in flash memory 104. In the mobile telephone, data such as voice, image, and electronic mail can be exchanged by well-known radio communication via the antenna 101. Received data is stored into the built-in flash memory 104 under control of the CPU 100. Also, a user can enter data of a contact list, incoming call melody and electronic mail through the key-input portion 102, and voice data through the microphone 103. Such input data is also stored into the built-in flash memory 104. The data stored in the built-in flash memory 104 can be transferred to an external storage device (a personal computer or the like). On the other hand, the data stored in the external storage device can be transferred to the built-in flash memory 104. The built-in flash memory 104 performs data write/read and data communication with the external storage device under the control of the CPU 100.

In the above-described mobile telephone, the capacity of the built-in flash memory 104 is not large in general. Therefore, necessary data to be stored is usually transmitted to the external storage device. For example, when the user operates the key-input portion 102 to instruct data transfer, the CPU 100 reads out the data to be transferred from the built-in flash memory 104 and transfers it to the external storage device according to the user's instruction.

As another conventional example, a mobile telephone employing a flash memory card has been known. In this example, the flash memory card is attached to the mobile telephone, and necessary data of the data stored in the built-in flash memory 104 is transferred to the flash memory card. On the other hand, necessary data of the data stored in the flash memory card can be read out and then be stored in the built-in flash memory 104.

Recently, in the case where a program in the portable telephone is upgraded, such a service that the required programs for use in portable telephones are transferred via the Internet is getting to be realized by service providers. A flash memory card is considered to be effective in providing such service.

The program transfer using the flash memory card is briefly described below.

FIG. 2 shows an example to transfer a program to the portable telephone. The following two kinds of methods for transferring a program to the mobile telephone 200 are considered: one method to download the program directly to the mobile telephone 200 by wireless communication; and the other method to provide the program to the mobile telephone 200 with the flash memory card 202. In this case, the latter method employing the flesh memory card will be described.

The flash memory card 202 is designed to be connected to both of the mobile telephone 200 and the personal computer 201. Since the personal computer 201 can connect to the Internet 203, it can obtain such a service that the programs for portable telephone is downloaded from a predetermined server of service provider (not shown).

In the case where the portable telephone 200 downloads a necessary program into the flash memory card 202, first, the flash memory card 202 is inserted into the personal computer 201 connected to the Internet 203. Next, when the programs for portable telephone has been downloaded from the predetermined server of the service provider, the programs are stored in the flash memory card 202. Then, the flash memory card 202 storing the program is removed from the personal computer 201 and is inserted into the mobile telephone 200. Furthermore, the required program is loaded from the flash memory card 202 to the mobile telephone 200. In this manner, a program download service can be obtained.

In the above-described conventional mobile telephone, however, data or programs are transferred from one medium to another without taking into consideration the concealment of the data or programs stored in the built-in flash memory, the flash memory card and the external storage device. Therefore, a third party can easily acquire the stored data without proper authorization. Since, so far, there has not been any mobile telephone having a function of preventing unauthorized retrieval of stored data by a third party, the development of such a mobile telephone has been one of critical issues.

There have been proposed several techniques of preventing a third party from unauthorized access to stored data. In Japanese Patent Application Unexamined Publication Nos. 11-205304 and 11-224189, a decryption key necessary for decryption of the encrypted data is previously stored in a memory and is encrypted before read out from the memory. Since the decryption key is encrypted and transferred to outside, unauthorized access to the stored data can be effectively prevented.

However, these techniques are designed to prevent the tapping of a decryption key transferred between different devices, for example, between a game maker and an IC card or between an IC card and an IC card reader/writer. The decryption key itself has been stored in the IC card. Further, these techniques are not designed for mobile telephones.

### SUMMARY OF THE INVENTION

An object of the present invention is to provide a mobile communication device and a data concealing method allowing data to be stored and programs to be delivered with safety.

According to the present invent ion, a mobile communication device includes: a memory; a card interface to a card having at least an encryption key generator therein, wherein the encryption key generator generates an encryption key using a predetermined code; and a processor performing encryption of data to be stored in the memory and decryption of encrypted data stored in the memory, using the encryption key received from the card.

The encryption key generator may generate the encryption key by using the predetermined code and a random number generated according to a predetermined algorithm. The mobile encryption key generator may generate the encryption key by using the predetermined code and a previously stored key that has been stored as secret information in the card. The predetermined code may be an identification code that has been assigned to the card. The predetermined code may be a group code that has been assigned to the card, wherein the group code is shared in a predetermined group.

Preferably, the card interface detachably connects the card to the mobile communication device.

The memory may be a flash memory. The flash memory may be built in the mobile communication device.

The flash memory may be a flash memory card and the mobile communication device may further include a memory card interface for detachably connecting the flash memory card to the mobile communication device.

The memory may be an external memory and the mobile communication device may further include an external memory interface for detachably connecting the external memory to the mobile communication device.

The mobile communication device may further include an external memory interface for detachably connecting an external memory to the mobile communication device, allowing data exchange with the external memory, wherein the processor performs encryption of data to be stored in the external memory and decryption of encrypted data stored in the external memory, using the encryption key received from the card.

According to another aspect of the present invention, a data concealing method includes the steps of: instructing the card to generate an encryption key using a predetermined code that is previously stored in the card; and performing encryption of data to be stored in the memory and decryption of encrypted data stored in the memory, using the encryption key received from the card.

The predetermined code may be a group code that has been assigned to the card, wherein the group code is shared in a predetermined group. The group code may be an identification code of a company that provides a predetermined service to the mobile communication device. The group code may be an identification code of a company that produces the mobile communication device.

As described above, according to the present invention, data to be stored into the memory is encrypted using the encryption key generated from the predetermined code of the card and the encrypted data stored in the memory is decrypted using the encryption key generated from the predetermined code of the card. Therefore, the mobile communication device according to the present invention can effectively prevent a third party from obtaining the data stored in the memory, resulting in enhanced concealment of stored data.

Since the encryption key is generated by using the predetermined code and a random number or a previously stored key that has been stored as secret information in the card, more enhanced concealment of data can be achieved.

Further, in the case of using a group code as the predetermined code, the group code is shared in a predetermined group. Therefore, the concealed data can be easily shared among members of the same group, resulting in that the service providers and the makers of mobile telephone can more safely distribute programs only to the authorized users.

### BRIEF DESCRIPTION OF THE DRAWINGS

FIG. 1 is a block diagram showing an example of general configuration of a conventional mobile communication device;

FIG. 2 is a block diagram showing an example of a conventional method of delivering programs to a mobile telephone;

Fig. 3 is a block diagram showing an embodiment of a mobile communication device according to the present invention;

FIG. 4 is a schematic flow chart showing an encryption process executed in the mobile telephone of FIG. 1; and

FIG. 5 is a schematic flow chart showing a decryption process executed in the mobile telephone of FIG. 1.

### DESCRIPTION OF THE PREFERRED EMBODIMENTS

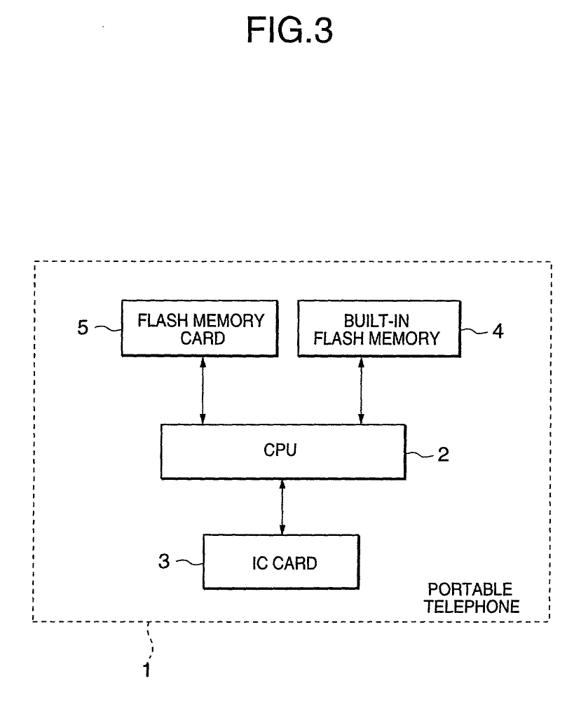

Referring to FIG. 3, a mobile telephone 1 includes a central processing unit (CPU) 2 and an IC card (or smart card) 3, and further includes a built-in flash memory 4 and/or a flash memory card 5. The IC card 3 may be detachably connected to a card connector, typically a card slot, providing an IC card interface in the mobile telephone 1.

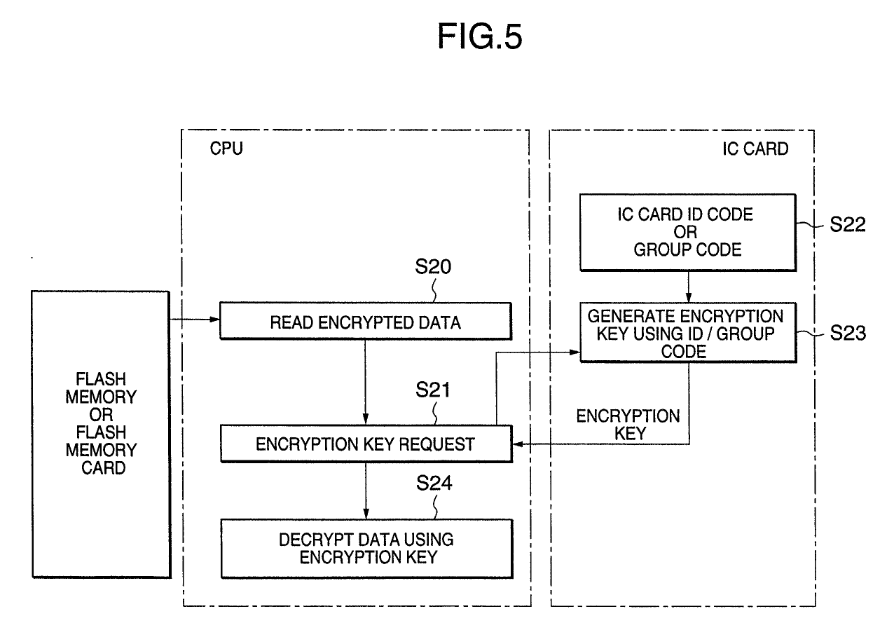

The IC card 3 has an IC (integrated circuit) chip therein, which is capable of computing and storing data, and further, when connected to the card slot, exchanging command and data with the CPU 2 through the IC card interface. The IC card 3 generates an encryption key necessary for encryption and decryption in response to an encryption key request received from the CPU 2. For example, a SIM (Subscriber identity Module) card may be used as the IC card 3. The built-in flash memory 4 and the flash memory card 5 are same as those shown in FIG. 5, in which data write/read is controlled by the CPU 2. The CPU 2 performs encryption and decryption of data stored in the built-in flash memory 4 and the flash memory card 5.

The IC card 3 has an IC card identification code or group code previously assigned thereto. The encryption key is generated by combining the IC card identification code or group code with the random number calculated by a predetermined algorism or a previously stored key as secret information in the IC card 3. Here, the IC card identification code is a unique code assigned to each IC card at the time of issuing the IC card, which is for example a subscriber number and so on. The group code is a code to be freely set by the user or the service provider. The user sets a group code predetermined for each specific group, and the service provider sets a group code predetermined for each service provider.

Operation

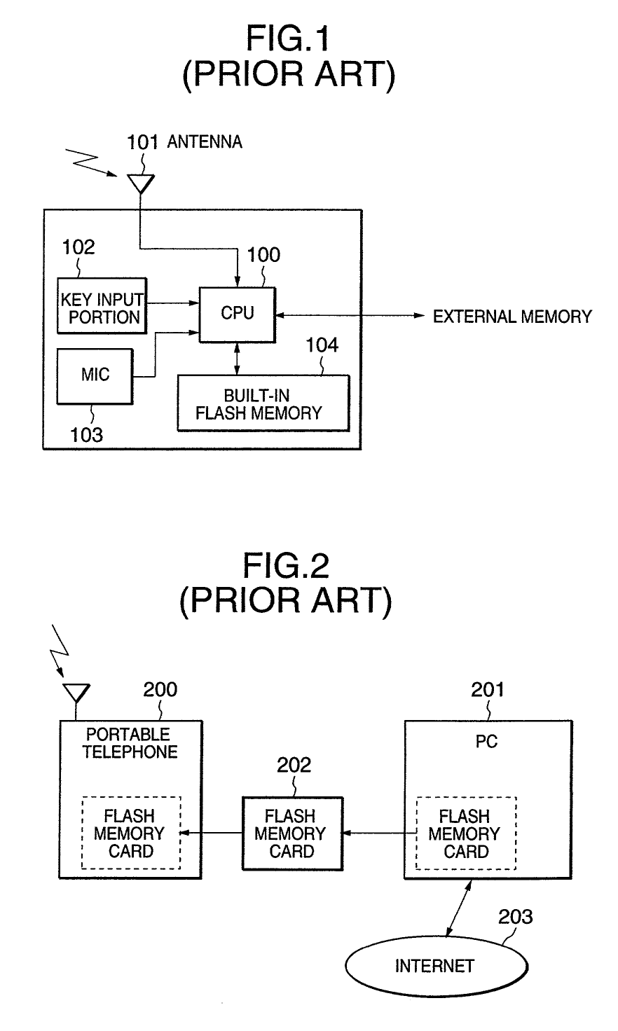

Next, the encryption and decryption of data in this mobile telephone will be described, taking as an example the case where voice data to be recoded in the mobile telephone is encrypted and decrypted. Here, voice data is data received through the antenna or a microphone as shown in FIG. 1 and is stored in the built-in flash memory 4 or the flash memory card 5 for recoding under the control of the CPU 2.

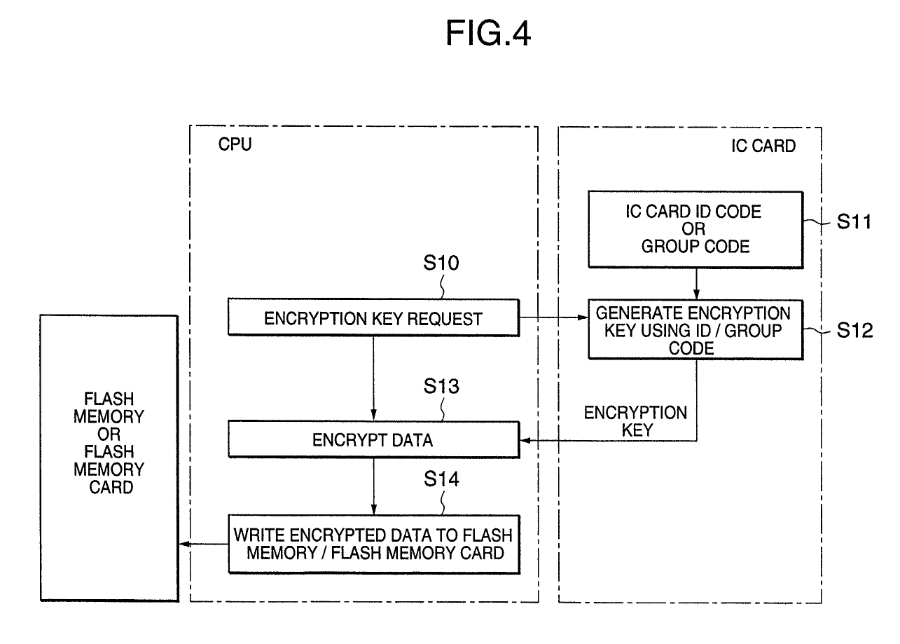

When a user wants to encrypt or decrypt data, first, the user has to obtain an IC card dealt with or specified by the service provider. The above-described IC card identification code or group code is previously assigned to this obtained IC card. These codes may be freely reset by the user which has purchased the IC card. Encryption process Referring to FIG. 4, the encryption of voice data is performed according to a flow of encryption procedure. In this example, first, the CPU 2 sends an encryption key request to the IC card 3 (step S10). The IC card 3, when receiving the encryption key request, reads out the IC card identification code or group code (step S11), and generates an encryption key by using the read-out identification code or group code and a random number calculated by the predetermined algorism or the previously stored key as secret information (step S12). For example, the encryption key is generated from a combination of the read-out identification/group code and the random number or the previously stored key. The IC card 3 sends this generated encryption key to the CPU 2.

When receiving the encryption key from the IC card 3, the CPU 2 executes the encryption of voice data using the encryption key (step S13). In this encryption process, the common key system (using a common key for encryption and decryption) or public key system (using different keys for encryption and decryption) may be applied. The encrypted voice data is stored in the built-in flash memory 4 or the flash memory card 5 under the control of the CPU 2 (step S14).

Decryption Process

Referring to FIG. 5, the encrypted voice data, which is stored in the built-in flash memory 4 or the flash memory card 5, is decrypted. First, the CPU 2 reads out the encrypted voice data from the built-in flash memory 4 or the flash memory card 5 (step S20), and sends a decryption key request to the IC card 3 (step S21).

The IC card 3, when receiving the encryption key request, reads out the IC card identification code or group code (step S22), and generates a decryption key by using the read-out identification code or group code and a random number calculated by the predetermined algorism or the previously stored key as secret information (step S23). As described before, the decryption key may be identical to the encryption key. The IC card 3 sends this generated decryption key to the CPU 2. When receiving the decryption key from the IC card 3, the CPU 2 executes the decryption of voice data using the decryption key (step S24).

As described above, voice data to be recoded and reproduced is encrypted and decrypted. It is the same with other data, such as contact list, electronic mail, delivered program.

Further, the same encryption and decryption processes can be applied to not only to data stored in the built-in flash memory 4 or the flash memory card 5 but also to data stored in the external storage device, resulting in the concealment of data transferred between the mobile telephone and the personal computer.

### Another Embodiment

In the above-described concealment of data, various usage patterns can be provided by appropriately using the IC card identification code and the IC card group code.

In the case where the IC card having an IC card identification code is used, the stored data is concealed as personal data. In this case, the mobile telephone permits the data stored therein to be read out and decrypted only when the IC card is used.

In the case where the IC card having the group code is used, the stored data is concealed as group-shared data. More specifically, the IC card having the common group code is used in a specific group. In this case, as far as in the same group, the data stored in others' mobile telephone can be accessed using the own IC card.

In the case where the specific code of the service provider is used as the group code, a program distributed by the service provider is encrypted and decrypted using the group code. This restricts the program distribution only to the users of the service provider. Similarly, in the case where the specific code of mobile telephones' maker is used as the group code, it restricts the program distribution only to the mobile telephones produced by the maker.

As described above, according to the present invention, the enhanced concealment of stored data can be achieved, resulting in a mobile communication device with high safety.

Further, since the concealed data can be easily shared among members of the same group, the service providers and the makers of mobile telephone can more safely distribute programs only to the authorized users.

1. A mobile communication device comprising:
a memory;
a card interface to a card having at least an encryption key generator therein, wherein the encryption key generator generates an encryption key using a predetermined code; and
a processor performing encryption of data to be stored into the memory and decryption of encrypted data stored in the memory, using the encryption key received from the card.

2. The mobile communication device according to claim 1, wherein the encryption key generator generates the encryption key by using the predetermined code and a random number generated according to a predetermined algorithm.

3. The mobile communication device according to claim 1, wherein the encryption key generator generates the encryption key by using the predetermined code and a previously stored key that has been stored as secret information in the card.

4. The mobile communication device according to claim 1, wherein the predetermined code is an identification code that has been assigned to the card .

5. The mobile communication device according to claim 1, wherein the predetermined code is a group code that has been assigned to the card, wherein the group code is shared in a predetermined group.

6. The mobile communication device according to claim 1, wherein the card interface detachably connects the card to the mobile communication device.

7. The mobile communication device according to claim 1, wherein the memory is a flash memory.

8. The mobile communication device according to claim 7, wherein the flash memory is built in the mobile communication device.

9. The mobile communication device according to claim 7, wherein the flash memory is a flash memory card, the mobile communication device further comprising:
a memory card interface for detachably connecting the flash memory card to the mobile communication device.

10. The mobile communication device according to claim 1, wherein the memory is a n external memory, the mobile communication device further comprising:
an external memory interface for detachably connecting the external memory to the mobile communication device.

11. The mobile communication device according to claim 1, further comprising:
an external memory interface for detachably connecting an external memory to the mobile communication device, allowing data exchange with the external memory,
wherein the processor performs encryption of data to be stored in the external memory and decryption of encrypted data stored in the external memory, using the encryption key received from the card.

12. A data concealing method in a mobile communication device comprising:
a memory; and
a card interface to a card having an IC (integrated circuit) chip therein,
the method comprising the steps of:
instructing the card to generate an encryption key using a predetermined code that is previously stored in the card; and
performing encryption of data to be stored in the memory and decryption of encrypted data stored in the memory, using the encryption key received from the card.

13. The method according to claim 12, wherein the encryption key is generated by using the predetermined code and a random number generated according to a predetermined algorithm.

14. The method according to claim 12, wherein the encryption key is generated by using the predetermined code and a previously stored key that has been stored as secret information in the card.

15. The method according to claim 12, wherein the predetermined code is an identification code that has been assigned to the card.

16. The method according to claim 12, wherein the predetermined code is a group code that has been assigned to the card, wherein the group code is shared in a predetermined group.

17. The method according to claim 16, wherein the group code is an identification code of a company that provides a predetermined service to the mobile communication device.

18. The method according to claim 16, wherein the group code is an identification code of a company that produces the mobile communication device.

19. The mobile communication device according to claim 1 is a mobile telephone, wherein the data to be stored into the memory is one of voice data, contact list data, electronic mail data, and delivered program data.

20. The method according to claim 12, wherein the mobile communication device is a mobile telephone, wherein the data to be stored into the memory is one of voice data, contact list data, electronic mail data, and delivered program data.
